(19) United States
(12) Patent Application Publication
(10) Pub. No.: US 2009/0285570 A1
(43) Pub. Date: Nov. 19, 2009

(54) HEATING APPARATUS AND HEATING APPARATUS SET

(76) Inventor: Te-Shun Yeh, Taoyuan Hsien (TW)

Correspondence Address: Kile Goekjian Reed & McManus PLLC;Suite 570, 12000 New Hampshire Avenue, NW, Washington, DC, 20036, US

(21) Appl. No.: 12/464,084

(22) Filed: May 11, 2009

(30) Foreign Application Priority Data
May 14, 2008 (TW) 97117682

(51) Int. Cl. H05B 3/82

(52) U.S. Cl. 392/501

(57) ABSTRACT

A heating apparatus is used for heating liquid in a receiving body. The heating apparatus includes a cover body and a heating part. The cover body is for covering an opening of the receiving body. One end of the heating part is located at the cover body and extends downwards from the bottom of the cover body. Therein, one end of the heating part that is on the cover body is electrically connected with a power line. The power line is electrically connected with a source of electric power. Thereby, the inner wall of the receiving body can be easily cleaned. Additionally, a heating apparatus set is also disclosed.

### BACKGROUND OF THE INVENTION

1. Field of the Invention

The present invention relates to a heating apparatus and a heating apparatus set; in particular, the present invention relates to a heating apparatus and a heating apparatus set that is used in a car.

2. Description of Related Art

As the pace of society increases, sometimes people have no time to eat dinner at the dinner table. According to market survey, for 2004, on average a person, eats dinner within a car 32 times that year. This fact is especially true for Americans, since Americans drive and utilizes cars more often so that it is more reasonable and common to eat dinner in a car. For example, on average it takes 25 minutes to travel from home to work. As for people who live in New York City or Chicago, it takes over 30 minutes to travel from home to work. A professor at The Culinary Institute of America, John Nihoff, has once stated that 19% of dinner, including donuts and baby carrots, are eaten in a car. Therefore, eating dinner in a car is a good way for people to fully utilize time. Moreover, as the concept of global village matures, there are now more travelers willing to step outside and vacation places that are further away, while entails driving a car while touring and vacationing. So that eating in a car is becoming more common and popular for people.

Currently, a typical dinner in a car includes soft-package yoghurt, heated cup soup, grain stick, cup salad, etc. On the other hand, some people thinks that it is dangerous to drive a car while grabbing a bag of French fires in hand, which is dangerous since it is similar to driving a car and having a cell phone in hand. One insurance company in American evaluates the order of severity for driving a car while having various kinds of food in hand. The order of severity in terms of dangerousness is coffee, hot soup, and fried corn cake. In the other words, although cup-holder cuisine is not the best choice when considering from the perspective of nutrition, nevertheless due to the popularity of cup-holder cuisine it is becoming a trend to sometimes have dinner in a car for people who lives in a city that commutes everyday.

Generally, liquid cup-holder cuisine is the favorite product for the driver or passenger. However, there are few peripheral products for this kind of liquid cup-holder cuisine designed for travel. This is due to the fact that liquid cup-holder cuisine usually needs to be added with hot water for user consumption, which may be technically dangerous and complicated while traveling; wherein some of the examples of liquid cup-holder cuisine include coffee or tea, etc. Traditionally, one solution is to provide a heating stick that is fastened onto the bottom of a cup and obtains electric power form the car power socket so as to heat the liquid, such as water in this case. Also, electric spoon may be directly placed into a kettle to heat water to a predetermined temperature so to facilitate the brewing of coffee while within a car.

However, the heating structure of the prior art has the following drawbacks.

1. The cup structure of the prior art is such that the heating stick is directly located on the base of the cup in order to heat liquid in the cup. However, the cup structure is not ergonomically designed for being operated by people. Because the heating stick protrudes from the base of the cup, the cleaning tool cannot be extended into the cup to clear the inner wall of the cup. Therefore, dirt and dregs are easily deposited on the inner wall and thereby negatively affects the user's health.

2. The cup structure of the prior art is such that the heating stick is located on the base of the cup in order to heat liquid in the cup. The power cable of the heating stick extends from the bottom of the cup. Take into consideration that the width of the cup-holder in a car usually has a pre-determined width for placing a cup. Therefore, the protruded power cable causes the cup to be too wide for easy placement of the cup within the cup-holder. Thus when the car is moving, the cup easily topples so that the hot liquid overflows.

3. The cup structure of the prior art is not complete. Because the heating stick is located at the base of the cup, the bottom of the cup needs to have a hole to be plugged for connecting with the heating stick. The completeness of the cup structure is destroyed. This means that the prior art needs an O-ring located around the edge of the hole in order to separate water. As time passed, the material of the O-ring is aged so that liquid in the cup results in leakage, and so that the heating cup cannot be used again.

4. Using the prior art electric spoon to heat liquid in a cup has the following drawbacks. After the electric spoon is used, no place or container are designed for placing the electric spoon and so that associated liquid may easily spray and smear the interior of the car. It is very inconvenient. Furthermore, after the electric spoon is used, the temperature of the electric spoon itself is still high. So that when the car is moving, people in the car may be scalded, thus the electric spoon is not suitable for being used in a car.

### SUMMARY OF THE INVENTION

One particular aspect of the present invention is to provide a heating apparatus and a heating apparatus set. The inner wall of a receiving body can be easily cleaned and the receiving body can be firmly and easily placed into the car cup-holder.

The heating apparatus is used for heating liquid in a receiving body. The heating apparatus includes a heating part and a cover body that is for covering an opening of the receiving body. One end of the heating part is located at the cover body and extends downwards from the bottom of the cover body. One end of the heating part that is on the cover body is electrically connected with a power line. The power line is electrically connected with a source of electric power.

The present invention also provides a heating apparatus set located on a cup-holder in a car. The heating apparatus set includes a receiving body located on the cup-holder and a heating apparatus having a cover body and a heating part. The receiving body has a receiving space. The cover body is for covering on the receiving body. One end of the heating part is located at the cover body and extends downwards from the bottom of the cover body into the receiving space of the receiving body. Therein one end of the heating part that is on the cover body is electrically connected with a source of electric power supplied by the car. The heating part is used for heating liquid in the receiving space.

The present invention has the following characteristics. The heating apparatus of the present invention is to connect the heating part on the bottom of the cover body. When the receiving body is to be cleaned, the heating part can be easily removed from the receiving body along with the cover body. Thereby the cleaning operation is not affected by the heating part. Thus the receiving body can be easily cleaned. Furthermore, because one end of the heating part that is on the cover body is electrically connected with an electric wire and the electric power extends out from the cover body, therefore the receiving body can be easily placed in the cup-holder in a car.

For further understanding of the present invention, reference is made to the following detailed description illustrating the embodiments and examples of the present invention. The description is for illustrative purpose only and is not intended to limit the scope of the claim.

### BRIEF DESCRIPTION OF THE DRAWINGS

FIG. 1 is a schematic diagram of a heating apparatus covering a receiving body of the present invention;

FIG. 2 is a perspective view of the heating apparatus covering a receiving body of the present invention;

FIG. 3 is an exploded perspective view of the heating apparatus and a receiving body of the present invention;

FIG. 4 is a schematic diagram of the heating apparatus set of the present invention;

FIG. 5 is a schematic diagram of the usage of the heating apparatus set of the present invention; and

FIG. 6 is an exploded perspective view of the heating apparatus set according to a second embodiment of the present invention.

### DETAILED DESCRIPTION OF THE PREFERRED EMBODIMENTS

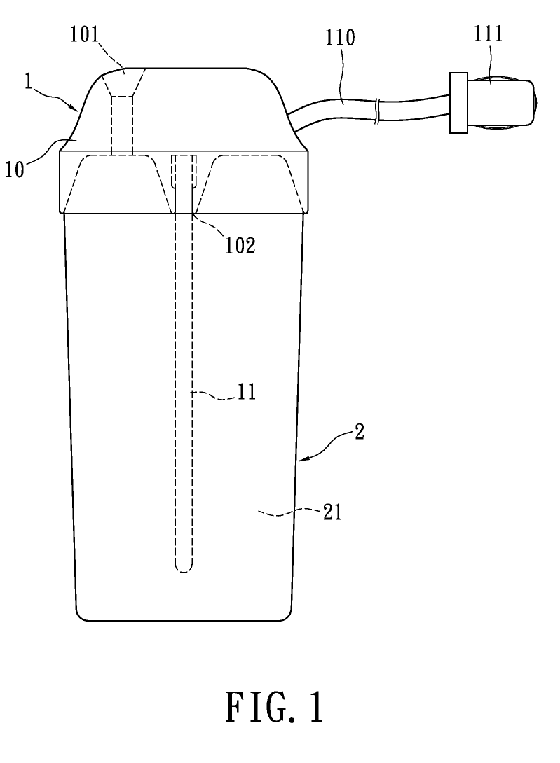

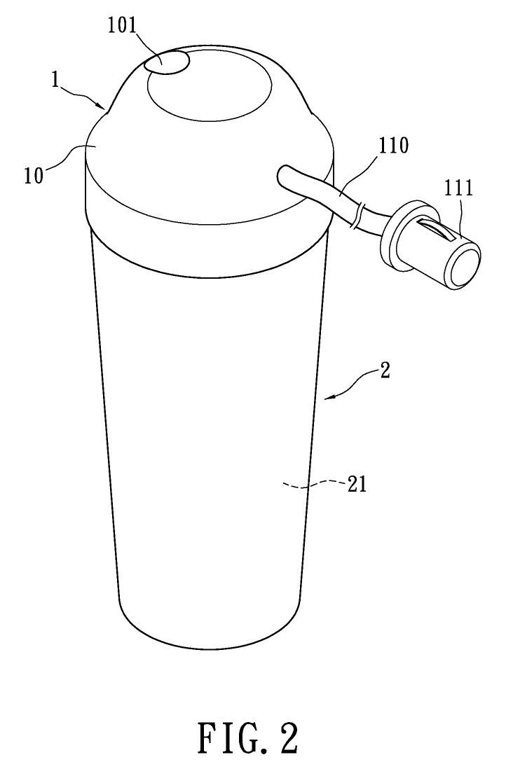

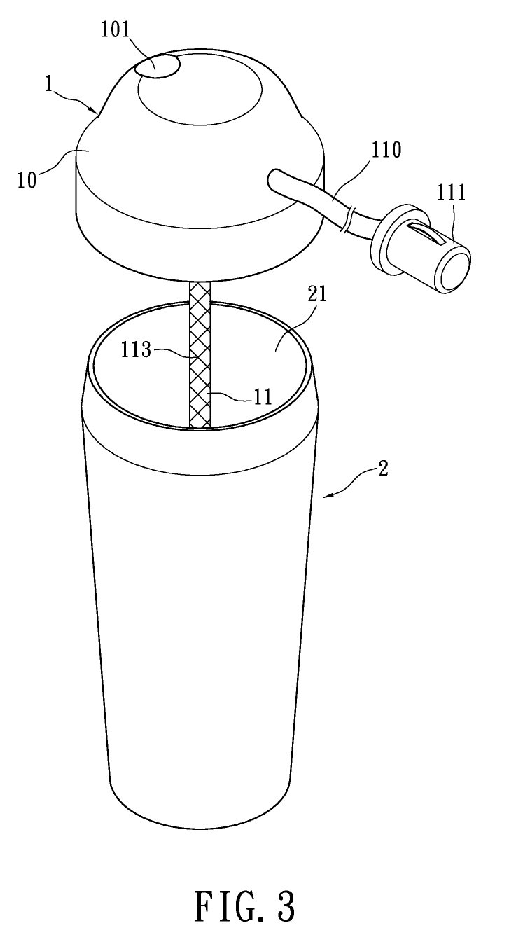

Reference is made to FIGS. 1-3. The heating apparatus 1 includes a cover body 10 and a heating part 11 for heating liquid in a receiving body 2.

The cover body 10 can be any shaped. In the present embodiment, the cover body 10 is circular-hat-shaped. The diameter of the opening of the cover body 10 is larger than the diameter of the opening of the receiving body 2 so that the cover body 10 easily covers the opening of the receiving body 2. The receiving body 2 can be a cup-structure, such as a cup or a bowl, for receiving liquid, such as water, but not limited thereby. The receiving body 2 has a receiving space 21.

One end of the heating part 11 is connected with the bottom surface of the cover body 10. In the present embodiment, the center of the bottom of the cover body 10 has a wedging trough 102. One end of the heating part 11 is wedged in the wedging trough 102, but not limited thereby. The heating part 11 also can be fastened onto the bottom of the cover body 10 by using screws or adhesives. Moreover, one end of the heating part 11 that is wedged with the wedged trough 102 has a power line 110. The power line 110 extends from interior of the cover body 10 to outside of the cover body 10. The power line 110 passes through the cover body 10 and extends to outside of the cover body 10. Another end of the electric wire 110 has a plug 111 for plugging to an external power source, such as an external electric power socket, so as to provide the required power fort the heating part 11. In the present embodiment, the heating part 11 is a heating stick made of metal material. The plug 111 is a car plug for plugging the source of electric power of a car, such as a DC-12V car cigar-lighter socket, but the present invention is not limited to thereby. The plug 111 can also be electrically connected with other type electric power socket via a power adaptor, such as a household power. The heating apparatus 1 can be versatile and various. Moreover, the heating part 11 also has other characteristics. For example, an electronic IC is used for preventing the water temperature from being too high, or a water temperature control unit is used for setting the heating temperature by a user. The heating part 11 can be a tube-shaped electric heating tube. It has a high heat versus watt ratio and can be manufactured into a variety of formats, such as fastening flake, tooth opening, or stainless steel host, so that the heating part 11 can be easily installed on the cover body 10. The outer surface of the tube-shaped electric heating tube is wrapped with a silicon rubber protection cover 113 to fully separate vapor, and thus is suitable for a moist operation environment, such as an environment designed for heating liquid. The heating part 11 can also be a soft electric heating flake. The soft electric heating flake is a silicon rubber electric heating flake. Its structure strength is strong and it is soft so that it can be a heat source for use within a car.

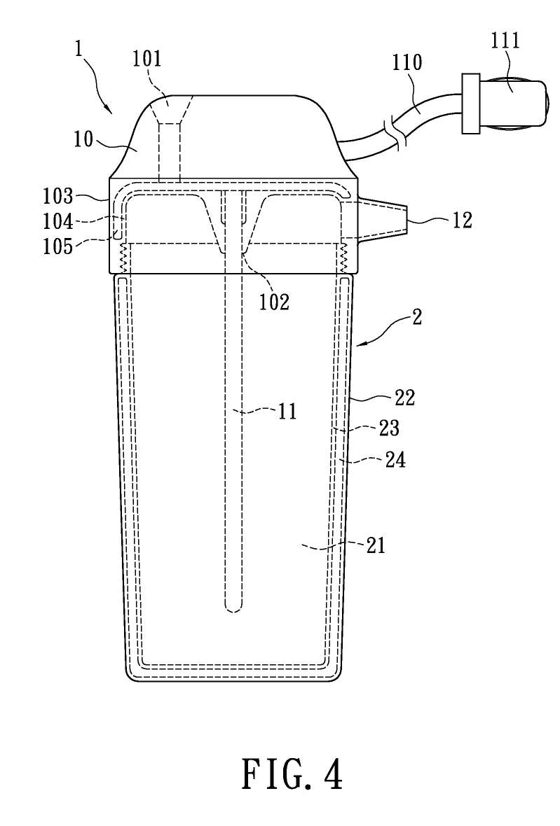

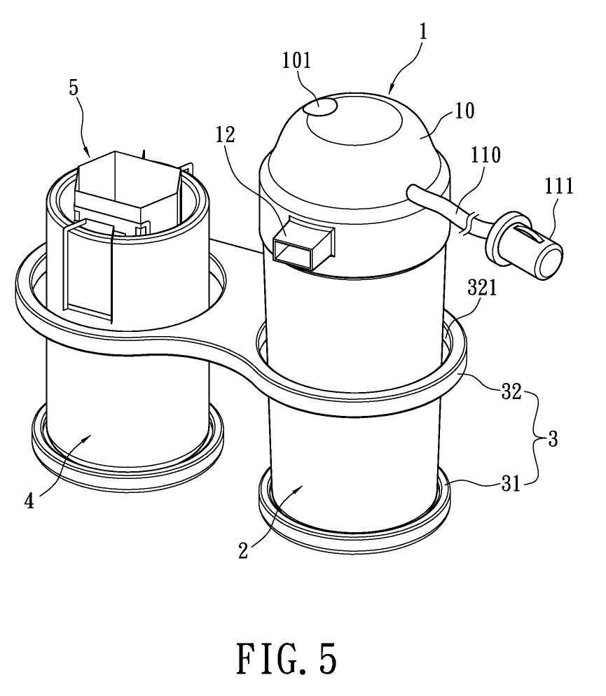

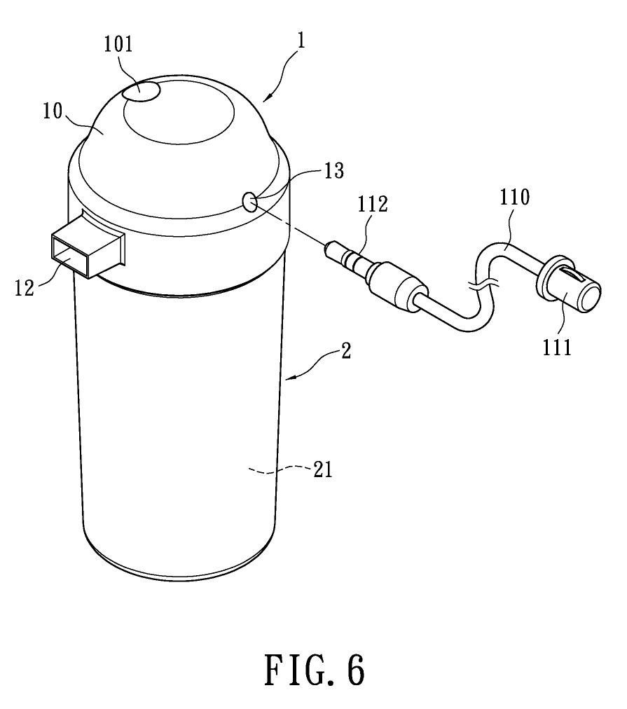

Reference is made to FIGS. 4 and 5. The present invention also provides a heating apparatus set that is located on a cup-holder in a car. The heating apparatus set includes a heating apparatus 1 and a receiving body 2. The structure of the heating apparatus 1, such as cover body 10 and heating part 11, are the same as above, and so descriptions thereof are not repeated again. The cover body 10 of the heating apparatus 1 further has a water outlet 12. The user can pour out liquid that has been received in the receiving body 2 via the water outlet 12. The cup-holder 3 has a carrying portion 31 and a holding portion 32. The holding portion 32 has two holding holes 321. The receiving body 2 passes through the holding holes 321 and is located on the carrying portion 31. The receiving body 2 has a receiving space 21. The cover body 10 covers on the receiving body 2. One end of the heating part 11 is located on the cover body 10 and extends downwards into the receiving space 21 via the bottom of the cover body 10. In the present embodiment, one end of the heating part 11 that is wedged with the wedging trough 102 has a power line 110. The power line 110 extends to outside from the interior of the cover body 10. Another end of the power line 110 has a plug 111. The plug 111 is a car plug for being plugged into an electric power source in a car for electrical connection. Reference is made to FIG. 6. The cover body 10 has a plug hole 13. In the plug hole 13, there are a conducting pin and a conducting wire (not shown in the figure) so that the plug hole 13 is electrically connected with one end of the heating part 11 that is wedged with the cover body 10. The plug hole 13 can be connected with a connector 112, wherein the connector 112 can be plugged with a power line. The plug 111 located at another end of the power line 110 can be plugged with a source of electric power within a car.

In the present embodiment, the cover body 10 has a first ceramic layer 103, a second ceramic layer 104, and an air layer 105. The first ceramic layer 103 and the second ceramic layer 104 are made of tourmaline powder and ceramic soil that are burnt under 1300° C. Each cubic centimeter generates 1000-2000 anions, and emits far infrared with 7-14 μm wavelength that is good for people. The air layer 105 is sealed between the first ceramic layer 103 and the second ceramic layer 104 to form a hollow structure for separating heat and maintaining temperature.

Similarly, the receiving body 2 also has a first ceramic layer 22, a second ceramic layer 23, and an air layer 24. The first ceramic layer 103 and the second ceramic layer 104 can generate anions and emits far infrared that is good for people. The air layer 24 is sealed between the first ceramic layer 22 and the second ceramic layer 23 so as to form a hollow structure for separating heat and maintaining temperature.

When the user is driving a car, the plug 111 of the heating part 11 is plugged into the car's electric power socket. By providing electric power, the heating part 11 heats the liquid in the receiving body 2 for the user. As shown in FIG. 5, the user pours the heated water into the cup 4 placed on the cup-holder 3. The cup 4 has a tea bag or coffee bag 5. The user can drink tea or coffee in a car.

The heating apparatus 1 further includes an alarm unit 101 located on the cover body 10 for informing the user regarding the heating status so as to improve the safety of the heating apparatus 1. For example, in the present embodiment, the alarm unit 101 is a steam whistle. It can emit sound by utilizing the vapor pressure of the liquid in the receiving body 2 in order to inform the user of the heating status. For improving the safety, a protection cover 113, such as a heat-separating screen, is covered on the heating apparatus 1 so as to reduce the chance of the heating part 11 of the heating apparatus 1 burning the human body or other objects, such as seat pad or car decoration. In another embodiment, the heating apparatus 1 further includes a receiving structure (not shown in the figure) located at one side of the receiving body 2. After the user takes the heating apparatus 1 out from the receiving body 2, the heating part 11 of the heating apparatus 1 can be placed into the receiving structure.

The heating part 11 further has a sensor (not shown in the figure) to provide a waterless automatic electric power protection function in order to improve the safety of the heating apparatus 1.

The edge of the cover body 10 of the heating apparatus 1 further includes a first wedged structure. The upper edge of the opening of the receiving body 2 has a second wedged structure (not shown in the figure). The first wedged structure and the second wedged structure can be wedged together so that the cover body 10 can be wedged onto the receiving body 2. Therefore, the liquid that is being heated does not overflow due to vibration. At the same time, the heating efficiency of the liquid is increased. For example, the first wedged structure is a wedged lock and the second wedged structure is a wedged tongue, but the present invention is not limited thereby.

The present invention has the following characteristics.

1. The usage of the heating apparatus is easy. Because the heating part 11 is located at the cover body 10, the power line 110 of the heating part extends to outside from the cover body 10. Therefore, the receiving body 2 can be easily placed on the cup-holder of the car. The interference problem of the prior art that the wire extends from the base of the receiving body 2 is solved.

2. The structure of the heating part 11 being located on the cover body 10 can solve the problem of the cup being difficult to clean due to fact that the heating stick is located at the bottom of the cup. The cover body 10 of the heating part 11 is applicable to a variety of cups, and so thereby is able to solve the problem of the prior art heating stick having limited applicability other cups due to the fact that the prior art heating stick is fastened on the bottom of the cup.

3. The heating part 11 being located at the cover body 10 can ensure that the liquid in the receiving body 2 does not overflow. On the other hand, for the structure of the prior art, the heating stick is located at the bottom of the cup, so that when the usage time is long or the hole locations is shifted due to the screwed wedged lock, liquid may leak out or overflow. The cup of the receiving body 2 in accordance to the present invention is complete and thereby solves the drawbacks of the prior art.

4. Both the cover body 10 and the receiving body 2 have two ceramic layers to generate anions so as to balance the anions on human body, which induces relaxation. The anions can also to a certain extend improve the water quality. The ceramic layer structure can also emit far infrared that is good for health. The far infrared can permeate into the subcutaneous tissue and blood vessel of the human body so as to generate the resonance symptom (this is due to the fact that the wavelength of the far infrared is similar to the wavelength of the far infrared emitted from human body). The human body is warmed which promotes circulation of the blood.

The description above only illustrates specific embodiments and examples of the present invention. The present invention should therefore cover various modifications and variations made to the herein-described structure and operations of the present invention, provided they fall within the scope of the present invention as defined in the following appended claims.

What is claimed is:

1. A heating apparatus, used for heating liquid in a receiving body, comprising:
a cover body for covering an opening of the receiving body; and
a heating part, wherein one end of the heating part is located at the cover body and extends downwards from the bottom of the cover body, one end of the heating part that is on the cover body is electrically connected with a power line, and the power line is electrically connected with a source of electric power.

2. The heating apparatus as claimed in claim 1, wherein the cover body further has an alarm unit, and the alarm unit is a steam whistle.

3. The heating apparatus as claimed in claim 2, wherein outer edge of the heating part is covered with a protection cover.

4. The heating apparatus as claimed in claim 1, wherein the source of electric power is a household electric power or an electric power within a car.

5. The heating apparatus as claimed in claim 4, wherein the power line extends to outside from the interior of the cover body and has a plug.

6. A heating apparatus set, located on the cup-holder in a car, comprising:
a receiving body located on the cup-holder, wherein the receiving body has a receiving space; and
a heating apparatus having a cover body and a heating part, wherein the cover body is for covering the receiving body, one end of the heating part is wedged with the cover body and extends downwards from the bottom of the cover body into the receiving space of the receiving body, one end of the heating part that is on the cover body is electrically connected with a source of electric power within the car;
wherein the heating part is used for heating liquid in the receiving space.

7. The heating apparatus set as claimed in claim 6, wherein the cover body further has an alarm unit, and the alarm unit is a steam whistle.

8. The heating apparatus set as claimed in claim 6, wherein outer edge of the heating part is covered with a protection cover.

9. The heating apparatus set as claimed in claim 6, wherein one end of the heating part that is wedged with the cover body has a power line, the power line extends to outside from the interior of the cover body and has a plug, and the plug is electrically connected with the source of electric power within the car.

10. The heating apparatus set as claimed in claim 6, wherein the cover body has a plug hole, the plug hole is electrically connected with one end of the heating part that is wedged with the cover body, the plug hole may be connected with a power line through a connector, and the power line is electrically connected with a source of electric power within the car.

11. The heating apparatus set as claimed in claim 6, wherein the cover body has a first ceramic layer, a second ceramic layer, and an air layer, the first ceramic layer and the second ceramic layer generate anions and emit far infrared, and the air layer is located between the first ceramic layer and the second ceramic layer.

12. The heating apparatus set as claimed in claim 6, wherein the receiving body has a first ceramic layer, a second ceramic layer, and an air layer, the first ceramic layer and the second ceramic layer generate anions and emit far infrared, and the air layer is located between the first ceramic layer and the second ceramic layer.
